(19) United States
(12) Patent Application Publication
(10) Pub. No.: US 2009/0235798 A1
(43) Pub. Date: Sep. 24, 2009

(54) CUTTING UNIT

(76) Inventor: Bernd Loibl, Klettgau (DE)

Correspondence Address: BERENATO, WHITE & STAVISH, LLC, 6550 ROCK SPRING DRIVE, SUITE 240, BETHESDA, MD, 20817, US

(21) Appl. No.: 12/388,888

(22) Filed: Feb. 19, 2009

(30) Foreign Application Priority Data
Feb. 21, 2008 (DE) 202008002455.8

(51) Int. Cl. B26D 1/18; B26D 5/08

(52) U.S. Cl. 83/485; 83/614

(57) ABSTRACT

A cutting unit for arc-shaped and circular trimming of a sheet item has a guide device that comprises a guide bar along which is displaceably guided a knife carriage. The knife carriage comprises at least one cutting knife for trimming the sheet item. The guide device comprises a bearing body that has on the lower side a support which defines a support plane and with which the bearing body (4) is placeable onto the sheet item to be trimmed. The guide bar is mounted on the bearing body rotatably about a rotation axis perpendicular to the support plane, and extending away from the bearing body in a plane parallel to the support plane.

The invention relates to a cutting unit for arc-shaped or circular trimming of a sheet item, having a guide device that comprises a guide bar along which is displaceably guided a knife carriage that comprises at least one cutting knife for trimming the sheet item.

For presentation purposes, for example, it is often desirable to cut out a specific portion in a circular shape from a rectangular sheet item (which may be, for example, a photograph), or to provide arc-shaped indentations or corner fillets on the outer edge. Arc-shaped or circular trimming of a sheet item is not possible with the usual cutting units (cf. for example EP 1 475 201 A1) in which a guillotine cutting device and/or a rotary cutting device are present on a support plate, since only a linear cut can be carried out with these cutting units.

Cutting units that permit arc-shaped or circular trimming are, however, also known (cf. EP 1 582 317 A1 and DE 20 2006 002 320 U1). These cutting units comprise a guide device in the form of a circular guide bar onto which can be placed a knife carriage that is guided displaceably along the guide bar. The knife carriage can a cutting knife that, after placement of the knife carriage onto the guide bar, protrudes downward and thus, upon placement of the guide bar onto the sheet item to be trimmed, cuts into it (cf. EP 1 582 317 A1). In the case of the knife carriage according to DE 20 2006 002 320 U1, the cutting knife is located firstly in a raised position in which it does not protrude beyond the knife carriage; and for the trimming cut, after being placed onto the guide bar it is pushed downward in order to cut into the sheet item. The cutting knife itself can be embodied as a simple cutting blade (cf. EP 1 582 317 A1) or as a circular knife, rotatably mounted on the knife carriage, of a rotary cutting device; multiple such circular knives can also be provided on the knife carriage (cf. DE 20 2006 002 320 U1). After the guide bar is placed onto the sheet item, trimming is accomplished by displacing the knife carriage along the guide bar, effecting a circular trimming cut in accordance with the diameter of the guide bar.

A disadvantage with the known cutting units of this kind is that the diameter of the guide bar determines the radius of the trimming cut. At most two trimming radii can be implemented, one when the knife carriage is set in place so that the cutting knife acts on the outer side of the guide bar, and the other such that the cutting knife projects on the inner side of the guide bar. These cuffing units are also bulky, since the guide bar takes up considerable space depending on its diameter.

It is the object of the present invention to configure a cutting unit for circular trimming of a sheet item in such a way that, within certain limits, any trimming radii can be implemented, and so that it requires little space.

This object is achieved according to the present invention in that the guide device comprises a bearing body that has on the lower side a support which defines a support plane and with which the bearing body is placeable onto the sheet item to be trimmed, the guide bar being mounted on the bearing body rotatably about a rotation axis perpendicular to the support plane, and extending away from the bearing body in a plane parallel to the support plane. The basic idea of the invention is thus to mount the guide bar in a bearing body which is placeable onto the sheet item and about which the guide bar is rotatable. A cutting unit of this kind not only requires considerably less space, but also creates the possibility of implementing any desired trimming radii within the extension of the guide bar, so that the cutout can be adapted to particular circumstances, for example to the subject of a photo.

It is not impossible in principle for the guide bar to have a curved conformation. It is has proven advisable, however, to embody the guide bar as a linear guide. The connection between bearing body and guide bar should, in this context, be made by way of a bend, so that the longitudinal axis of the guide bar extends not through the rotation axis, but instead tangentially to it and thus to the bearing body.

Rotatable mounting of the guide bar on the bearing body can be implemented in various ways. It has proven to be advantageous if the guide bar ends in a bearing ring that surrounds the bearing body. In order to obtain good guidance on the bearing body and to interconnect the two in lossproof fashion, the bearing ring should fit into an annular groove on the bearing body.

The support of the bearing body should be finished in such a way that adhesion onto the sheet item to be trimmed is achieved in a slip-resistant a fashion as possible. This can be done, for example, by configuring the support of the bearing body as a support surface made of a rubber-elastic material. Knob-shaped elevations made of a material having a high coefficient of friction can, however, also be provided. Usefully, the bearing body projects on the upper side beyond the guide bar, so that rotational movement is not impeded when the bearing body is pressed from above onto the sheet item to be trimmed.

The cutting knife can be attached rigidly to the knife carriage, as in the case of the cutting unit according to EP 1 582 317 A1. This has the disadvantage, however, that the cutting knife must project outward beyond the knife carriage and thus constitutes a source of damage or even injury. A two-part configuration of the knife carriage is therefore preferable, with a slide provided for abutment against the guide bar and with a knife holder in which the cutting knife is arranged, the knife holder being movable at least substantially perpendicular to the support plane out of an inactive position into a cutting position. This creates the possibility of encapsulating the cutting knife in the inactive position, i.e. not allowing it to project outward beyond the knife carriage, so that the cutting knife presents no hazard in this position. This principle is implemented, for example, in the cutting unit according to DE 20 2006 002 320 U1. The knife holder is then preferably embodied as a knife carriage housing that can be impinged upon by force from above so that the cutting knife can be pushed down out of the inactive position into the cutting position. For the movement between the inactive and cutting positions, the knife holder can be mounted on the slide pivotably about an axis extending parallel to the support plane.

For guidance of the knife carriage on the guide bar, the slide should comprise a guide recess in which the guide bar is received. It can be embodied as a closed guide channel so that the guide bar is surrounded on all sides by the slide, i.e. it is removable from the guide bar only at its free end.

More versatile utilization of the cutting unit according to the present invention can be achieved by the fact that the slide comprises a second guide recess that extends perpendicular to the first guide recess and allows the knife carriage to be placed with a 90-degree rotation onto the guide bar and displaced along the guide bar. This makes it possible, after changing the placement of the knife carriage, to perform trimming cuts along the guide bar, i.e. to make straight cuts in the case of a linear guide. The guide recess can be implemented, for example, as a guide groove that is open on the lower side.

For execution of a circular-arc-shaped trimming cut, it is very helpful if the knife carriage inherently maintains its position with respect to the guide bar during the cutting operation. This can be achieved most easily by adjusting the frictional resistance, by corresponding adaptations of the mutually contacting surfaces of the knife carriage and guide bar, to be so high that a kind of self-locking occurs. This, however, prevents displacement of the knife carriage along the guide bar. In order to enable easy and accurate displacement, the knife carriage should comprise a manually actuable clamping device by means of which the knife carriage can be clamp-locked to the guide bar. The knife carriage can be fastened in any desired location using such a clamping device, so that self-locking adaptation of the guide bar and knife carriage is not necessary, but instead sufficient clearance between the two can be provided that the knife carriage is smoothly displaceable when the clamping device is deactivated.

In order to facilitate transport of the cutting device according to the present invention, it may be advantageous if the knife carriage is removable from the guide bar. If the knife carriage is merely placed onto the guide bar, this can occur by simply lifting. If the knife carriage surrounds the guide bar, the latter should taper at the end so that the knife carriage can be pulled off the guide bar at the free end.

The cutting knife can be embodied, in a manner known per se, as a simple cutting blade. A substantially cleaner trimming cut can be achieved, however, using a rotary cutting device in which at least one circular knife is mounted on or in the knife carriage rotatably about a rotation axis parallel to the support plane, as is the case, for example, with the cutting unit according to DE 20 2006 002 320 U1. The circular knife can also be retained replaceably, for example so that a wavy cut or perforations can be effected. The knife carriage and guide bar should preferably be associated in such a way that the rotation axis of the circular knife intersects that of the guide bar at right angles.

It is also possible to provide multiple cutting knives instead of a single cutting knife, for example in an arrangement such as that in the cutting unit according to DE 20 2006 002 320 U1.

Lastly, provision is made according to the present invention that the guide bar is freely rotatable in the bearing body, i.e. the rotation angle is not subject to any limitation. The basic idea of the invention is, however, also implemented in the case of a cutting unit in which the rotation angle is limited, so that only circular-arc-shaped cuts can be implemented.

The invention is illustrated in more detail, with reference to an exemplifying embodiment, in the drawings, in which:

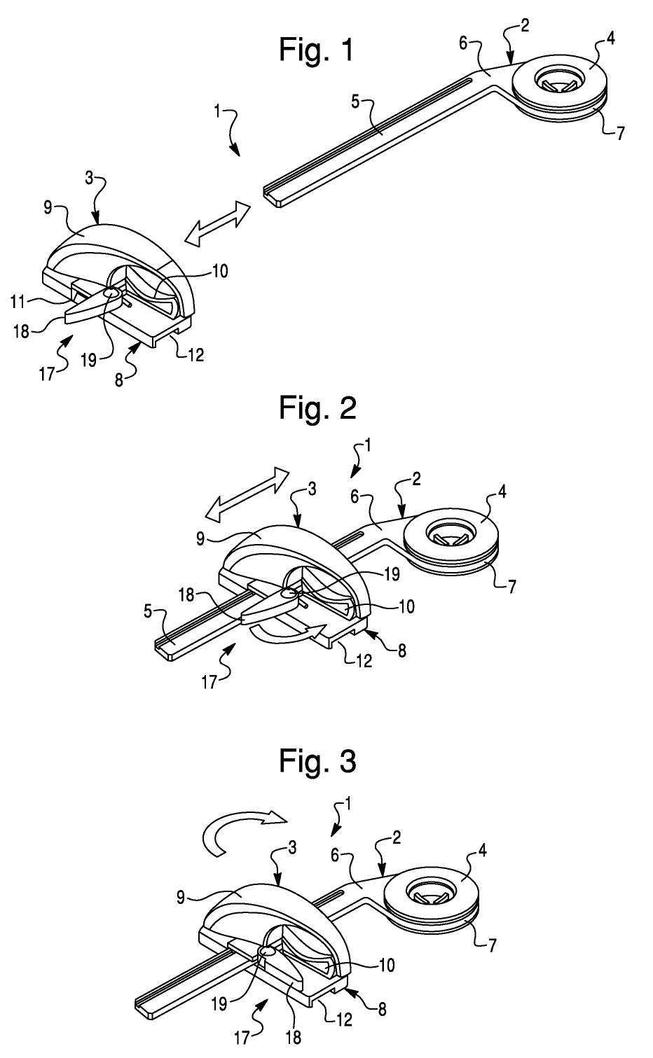

FIG. 1 is a perspective view of the cutting unit according to the present invention with the knife carriage removed;

FIG. 2 is a perspective view of the cutting unit according to FIG. 1, with the knife carriage placed onto the guide bar;

FIG. 3 is a perspective view of the cutting unit according to FIGS. 1 and 2, with the knife carriage clamp-locked onto the guide bar;

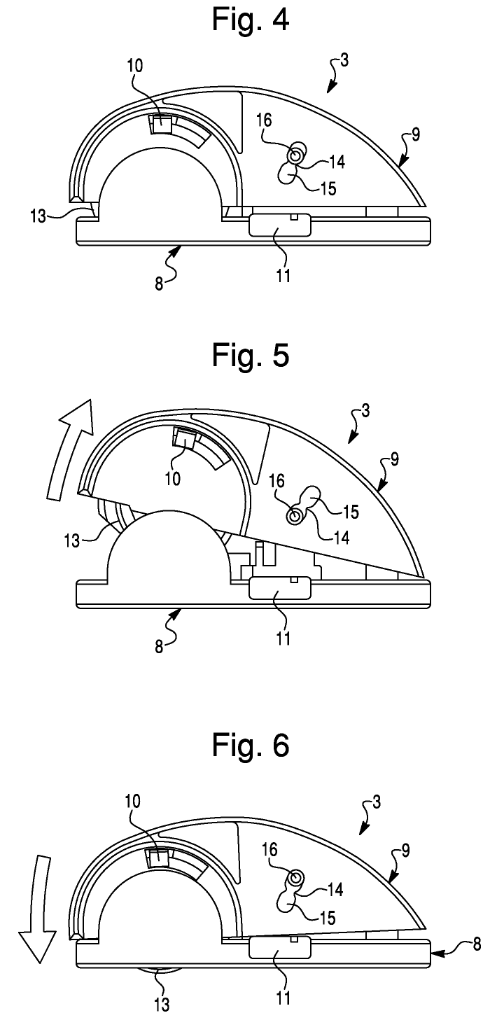

FIG. 4 is a side view of the knife carriage for the cutting unit according to FIGS. 1 to 3, in the inactive position;

FIG. 5 is a side view of the knife carriage according to FIG. 4 in a knife-changing position;

FIG. 6 is a side view of the knife carriage according to FIGS. 4 and 5 in the cutting position;

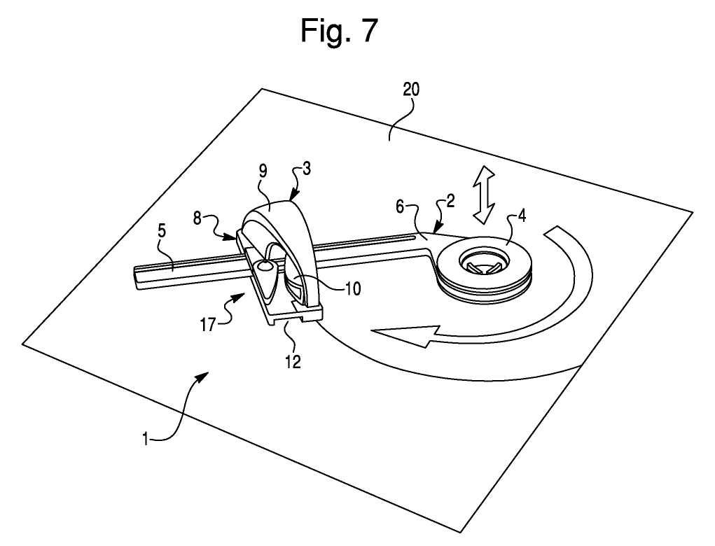

FIG. 7 is a perspective view of the cutting unit according to FIGS. 1 and 3 during the cutting operation.

Cutting unit 1 depicted in FIGS. 1 to 3 is made up substantially of a guide device 2 and a knife carriage 3. The two can be separated from one another, as is evident from FIG. 1. They are, however, connectable to one another for the cutting operation, as FIGS. 2 and 3 to 7 show.

Guide device 2 is made up of a flat, cylindrical bearing body 4 and a guide bar 5 that is rectilinear except for the join to bearing body 4. Bearing body 4 is configured to be flat on the lower side and is equipped there with a covering that has a high coefficient of friction. The connection between guide bar 5 and bearing body 4 is effected via a bent 6 and a bearing ring 7 that completely surrounds bearing body 4 and is enclosed internally in a bearing groove on bearing body 4. Guide bar 5, bend 6, and bearing ring 7 form one integral unit.

Because of the connection of bearing body 4 and guide bar 5, the latter is freely rotatable about the vertical axis of bearing body 4. As a result of bend 6, the longitudinal axis of guide bar 5 proceeds laterally past the side of bearing body 4, i.e. does not intersect the vertical axis of bearing body 4.

Knife carriage 3 has a slide 8 as a base, and has on the upper side a hood-shaped knife housing 9 that is mounted on slide 8 pivotably about an axis extending parallel to the longitudinal axis of guide bar 5. Mounted in freely rotatable fashion in knife housing 9 is a circular knife that, in the views according to FIGS. 1 to 3, is concealed by a knife holder 10. The circular knife is mounted in knife housing 9 freely rotatably about an axis proceeding parallel to the longitudinal axis of guide bar 5. The rotation axis of the circular knife extends at right angles through the vertical axis of bearing body 4, i.e. bend 6, and therefore the offset of bearing bar 5 with respect to the vertical axis of bearing body 4, are dimensioned so that the two aforesaid rotation axes intersect at right angles.

Slide 8 is penetrated by a guide channel 11 whose walls fit around guide bar 5 on all sides after knife carriage 3 is slid on (cf. FIGS. 2 and 3). Slide 8 and therefore knife carriage 3 are, in this fashion, guided in longitudinally displaceable fashion on guide bar 5, the fits in guide channel 11 being dimensioned so that knife carriage 3 can be moved without exertion of a great deal of force, and therefore precisely, away from or toward bearing body 4.

Slide 8 additionally comprises a guide groove 12, open toward the bottom, that extends perpendicularly to guide channel 11 over the entire lower side of slide 8. This creates the possibility of placing knife carriage 3 on guide bar 5 not only in the manner evident from FIGS. 2 and 3, but also in a manner rotated 90 degrees, so that guide bar 5 is received by guide groove 12 and knife carriage 3 is displaceable along guide bar 5.

FIGS. 4 to 6 show knife carriage 6 (without guide bar 5) from the side that faces away from the side visible in FIGS. 1 to 3. In FIG. 4, knife housing 9 is in the inactive position. In this position, circular knife 13 that is visible here protrudes with its lower region into an open slot in slide 8, but does not project downward beyond its lower side. Knife housing 9 is held in this position by a spring (not depicted in further detail here) that pushes upward the portion of knife housing 9 in which circular knife 13 is mounted. The inactive position is delimited at the top by a constriction 14 in a slot 15 in the side of knife housing 9 into which a stud 16 fits from inside. Stud 16 is rigidly connected to slide 8. Constriction 14 then functions as a stop.

It is evident from FIG. 5 that constriction 14 is intended merely to produce an increased resistance. Specifically, knife housing 9 has been manually pivoted clockwise and upward with respect to slide 8, stud 16 having gone past constriction 14 in slot 15 and having come into contact against its lower end. In this position, circular knife 13 is removable, by corresponding handling of knife holder 10, on the side facing away in the views according to FIGS. 4 to 6 and is replaceable by another circular knife, for example one that produces a wavy cut or perforations.

In order to bring circular knife 13 into the cutting position depicted in FIG. 6, knife housing 9 is impinged upon by force from above in such a way that it is rotated counter-clockwise (cf. the arrow depicted in FIG. 6). In the course of this motion, circular knife 13 passes through the slot in slide 8 and then projects on the lower side beyond slide 8. The lowering motion is limited by the upper end of slot 15.

For the cutting operation depicted in FIG. 7, cutting unit 1 is first assembled, i.e. knife carriage 3 is slid from the free end of guide bar 5 onto said bar, in which context guide bar 5 is received by guide channel 11, i.e. passes through it. Knife housing 9 is, in this context, in the inactive position depicted in FIG. 4, in which circular knife 13 does not project beyond the lower side of side 8, i.e. is protected. The slid-on state is evident from FIG. 2.

Knife carriage 3 is then slid into the desired position, the distance between the circular knife and the center point of bearing body 4 constituting the radius for the trimming cut to be made. Once the desired position has been assumed, knife carriage 3 is fastened on guide bar 5. Provided for this purpose on slide 8 is a clamping device 18 that is actuable byway of a clamping lever 18. Clamping lever 18 is shaped onto a clamping cam 19 that, when clamping lever 18 is in the position according to FIG. 2, does not project into guide channel 11 but can be brought, by counter-clockwise rotation of clamping lever 18 (cf. the arrow in FIG. 2), into a position in which it projects into guide channel 11 and there ensures clamp-locking to guide bar 5. This state is apparent from FIG. 3.

Once adjusted in this fashion, cutting unit 1 can then be placed with the lower side of bearing body 4 onto a sheet item 20 to be trimmed, as is visible in FIG. 7. For the cutting operation, bearing body 4 is pressed manually against sheet item 20 so that it maintains its position. At the same time, pressure is exerted with the other hand onto the knife housing 9, with the result that knife housing 9 is pivoted out of the inactive position shown in FIG. 4 into the cutting position shown in FIG. 6, and circular knife 13 is moved into the cutting position and thus cuts into-sheet item 20. The exertion of downward pressure is combined with an exertion of force in a direction perpendicular to guide bar 5 (cf. the arrows in FIGS. 3 and 7), thereby initiating the rotary motion of guide bar 5 around bearing body 4. This is continued until the circular cut has been completed.

Thanks to guide groove 12, cutting unit 1 according to the present invention creates the possibility of also performing a rectilinear trimming cut. For this, knife carriage 3 is removed from guide bar 5, rotated 90 degrees, and then placed with guide groove 12 onto guide bar 5 in such a way that guide bar 5 is received by guide groove 12. Knife carriage 3 can then be displaced along guide bar 5, and a rectilinear trimming cut can be performed by pushing down knife housing 9.

1. A cutting unit (1) for arc-shaped and circular trimming of a sheet item (20), having a guide device (2) that comprises a guide bar (5) along which is displaceably guided a knife carriage (3) that comprises at least one cutting knife for trimming the sheet item (20),
wherein the guide device (2) comprises a bearing body (4) that has on the lower side a support which defines a support plane and with which the bearing body (4) is placeable onto the sheet item (20) to be trimmed, the guide bar (5) being mounted on the bearing body (4) rotatably about a rotation axis perpendicular to the support plane, and extending away from the bearing body (4) in a plane parallel to the support plane.

2. The cutting unit according to claim 1, wherein the guide bar (5) constitutes a linear guide.

3. The cutting unit according to claim 1, wherein the longitudinal axis of the guide bar (5) extends tangentially to the bearing body (4).

4. The cutting unit according to claim 1, wherein the guide bar (5) ends in a bearing ring (7) that surrounds the bearing body (4).

5. The cutting unit according to claim 4, wherein the bearing ring (7) fits into an annular groove on the bearing body (4).

6. The cutting unit according to claim 1, wherein the support of the bearing body (4) is embodied as a support surface made of a rubber-elastic material.

7. The cutting unit according to claim 1, wherein the bearing body (4) projects on the upper side beyond the guide bar (5).

8. The cutting unit according to claim 1, wherein the knife carriage (3) comprises a slide (8) that abuts against the guide bar (5); and the cutting knife (13) is arranged in a knife holder (10) that is movable at least substantially perpendicular to the support plane out of an inactive position into a cutting position.

9. The cutting unit according to claim 8, wherein in the inactive position, the cutting knife (13) does not project outward beyond the knife carriage (3).

10. The cutting unit according to claim 8, wherein the knife holder is embodied as a knife housing (9) that can be impinged upon from above in order to move the cutting knife (13) out of the inactive position into the cutting position.

11. The cutting unit according to claim 10, wherein the knife housing (9) is mounted on the slide (8) pivotably about an axis extending parallel to the support plane.

12. The cutting unit according to claim 8, wherein the slide (8) comprises a guide recess (11) in which the guide bar (5) is received.

13. The cuffing unit according to claim 12, wherein the guide recess is embodied as a guide channel (11) surrounding the guide bar (5) on all sides.

14. The cutting unit according to claim 8, wherein the slide (8) comprises a second guide recess (12) that extends perpendicular to the first guide recess (11) and allows the knife carriage (3) to be placed with a 90-degree rotation onto the guide bar (5) and displaced along the guide bar (5).

15. The cutting unit according to claim 14, wherein the guide recess is implemented as a guide groove (12) that is open on the lower side.

16. The cutting unit according to claim 1, wherein the knife carriage (3) comprises a manually actuable clamping device (17) by means of which the knife carriage (3) can be clamp-locked to the guide bar (5).

17. The cutting unit according to claim 1, wherein the knife carriage (3) is removable from the guide bar (5).

18. The cutting unit according to claim 1, wherein the knife carriage (3) constitutes a rotary cutting device on or in which at least one circular knife (13) is mounted rotatably about a rotation axis parallel to the support plane.

19. The cutting unit according to claim 18, wherein the knife carriage (3) and guide bar (5) are associated in such a way that the rotation axis of the circular knife (13) intersects that of the guide bar (5) at right angles.

20. The cutting unit according to claim 19, wherein multiple cutting knives are provided on the knife carriage.

21. The cutting unit according to claim 1, wherein the guide bar (5) is mounted freely rotatably around the bearing body (4).
